(19) United States
(12) Patent Application Publication
(10) Pub. No.: US 2022/0285979 A1
(43) Pub. Date: Sep. 8, 2022

(54) SYSTEM WITH MULTIPLE FUNCTIONS OF ENERGY STORAGE, INTERNET OF THINGS AND DISASTER COMMUNICATION AND CONTROL METHOD THEREOF

(71) Applicant: NATIONAL CHUNG SHAN INSTITUTE OF SCIENCE AND TECHNOLOGY, Taoyuan City (TW)

(72) Inventors: SHIH-CHANG TSENG, Taoyuan City (TW); SHU-HSIEN WEN, Taoyuan City (TW); CHIH-HSIEN CHUNG, Taoyuan City (TW); GWO-HUEI YOU, Taoyuan City (TW); KUO-KUANG JEN, Taoyuan City (TW)

(21) Appl. No.: 17/190,430

(22) Filed: Mar. 3, 2021

(51) Int. Cl. H02J 13/00; H02J 3/32; G05B 15/02

(52) U.S. Cl. CPC H02J 13/00002; H02J 13/00022; H02J 3/32; G05B 15/02

(57) ABSTRACT

A system with multiple functions of energy storage, Internet of things (IoT) and disaster communication is disclosed. The system includes an energy management controller connected to a power input, a digital meter, an energy storage battery pack, a power inverter, an automatic transfer switch system and a communication device with IoT and wireless communication function, and is used to control the energy storage battery pack into a charge/discharge mode or a protection mode according to a charge/discharge algorithm for the energy storage battery pack and to receive frequency conversion, voice or text messages from the communication device with IoT and wireless communication function. The energy management controller also controls the automatic transfer switch system to enable an emergency power supply control procedure when a utility power grid tripping occurs during a typhoon, an earthquake or any other emergency condition. A control method of the system is also disclosed.

### BACKGROUND OF THE INVENTION

### 1. Field of the Invention

The present disclosure relates to a system with multiple functions of energy storage, Internet of things (IoT) and disaster communication, and in particular to a system with multiple functions of energy storage, Internet of things (IoT) and disaster communication that can be applied to stores in remote areas, such as convenience stores. The present disclosure also relates to a control method of the system.

### 2. Description of the Related Art

Convenience stores have become very popular in many areas, such as in the United States and Asia. The density of convenience stores in Taiwan is even higher than that of the police stations. In Taiwan, convenience stores such as 7-Eleven, FamilyMart, Life and OK can be seen everywhere, even in remote areas, mountainous areas and off-shore islands, and have become an important link in the life of the general public.

The remote areas, the mountainous areas and the off-shore islands often require disaster rescue when a natural disaster occurs, including but not limited to typhoon, torrential rain and earthquake. If information about the persons requiring rescue and the suffered damages in the disaster areas can be transmitted to a central or local hazard mitigation center in real time, the hazard mitigation center would be able to have a clear idea about the disaster areas and arrange necessary rescue force and equipment immediately. However, most of the remote areas, mountainous areas and off-shore islands lack communication resources for disaster prevention and disaster protection, which possibly results in delayed disaster prevention and missed golden hour of rescue.

In conclusion, it is desirable to improve the disaster prevention and protection in the remote areas.

### BRIEF SUMMARY OF THE INVENTION

An objective of the present disclosure is to provide a system with multiple functions of energy storage, Internet of things (IoT) and disaster communication and a control method of the system. According to the system of the present disclosure and the control method thereof, an emergency power supply control procedure is enabled in the event of a disaster, such as a typhoon, an earthquake or any other emergency condition, so that the system can transmit data about the disaster areas to an emergency response center and receive instructions from the emergency response center. In addition, in view of the insufficient resources for disaster prevention and disaster protection in remote areas, the system and the control method thereof according to the present disclosure can be applied to stores, particularly the convenience stores and other stores in the remote areas to assist in disaster prevention and protection of these remote areas.

To achieve at least the above objective, one solution provided according to the present disclosure is a system with multiple functions of energy storage, Internet of things (IoT) and disaster communication. The system includes a power input for being grid-connected to input endpoints of a utility power source and a renewable power source; a digital meter for detecting information about the utility power, including the voltage, frequency, load current and power factor thereof; an energy storage battery pack connected to a direct current (DC) bus of the power input for storing and releasing electrical energy; a power inverter for connected to the power input and connected to the utility power grid in parallel for alternative current/direct current (AC/DC) power conversion, and also connected to the energy storage battery pack; an automatic transfer switch (ATS) system connected to the power inverter, for switching, when the utility power grid tripping occurs, to enable the energy storage battery pack for emergency power supply, and to supply power to a communication device with IoT and wireless communication function; a human-machine interface for displaying system state information in real time and adjusting basic parameters of the system, and the system state information including state information of the digital meter, the energy storage battery pack, the power inverter and the communication device with IoT and wireless communication function; and an energy management controller connected to the power input, the digital meter, the energy storage battery pack, the power inverter, the automatic transfer switch system and the communication device with IoT and wireless communication function, and the energy management controller for being used to control the energy storage battery pack into a charge/discharge mode or into a protection mode according to a charge/discharge algorithm for the energy storage battery pack and to receive at least frequency conversion, voice or text messages from the communication device with IoT and wireless communication function, and the energy management controller controlling the automatic transfer switch system to enable an emergency power supply control procedure when a utility power grid tripping occurs in any emergency condition.

In an embodiment, the communication device with IoT and wireless communication function is used to transmit data to an emergency response center and to receive instructions from the emergency response center when the utility power grid tripping occurs in an emergency condition.

In an embodiment, the system is applied to a store, and the energy management controller is used to adjust an operational power demand of the store when a calculation shows a required power consumption of the store is larger than a contract capacity thereof, so that the power consumption of the store meets the contract capacity.

In an embodiment, the system is applied to a store, and the energy management controller is used to control the power inverter to adjust a ratio of power supplied by the utility power grid to power supplied by the energy storage battery pack, so as to regulate a required power consumption of the store and to control a power conversion at peak and off-peak load time.

To achieve at least the above objective, another solution provided according to the present disclosure is a system with multiple functions of energy storage, Internet of things (IoT) and disaster communication. The system includes a power input grid-connected to input endpoints of a utility power source and a renewable power source; a digital meter for detecting information about the utility power, including the voltage, frequency, load current and power factor thereof; an energy storage battery pack connected to a direct current (DC) bus of the power input for storing and releasing electrical energy, and for adjusting an operational power demand of a convenience store when the power consumption thereof exceeds a contract capacity, so as to reduce an over consumption fine; a power inverter connected to the power input to be connected to the utility power grid in parallel for alternative current/direct current (AC/DC) power conversion, and also connected to the energy storage battery pack for regulating a required power consumption of the convenience store and for controlling a power conversion at peak and off-peak load time; a communication device with IoT and wireless communication function; an automatic transfer switch (ATS) system connected to the power inverter and being capable of switching on the energy storage battery pack for the latter to emergently supply power to the communication device with IoT and wireless communication function when a utility power grid tripping occurs; a human-machine interface for displaying system state information in real time and adjusting basic parameters of the system, and the system state information including state information of the digital meter, the energy storage battery pack, the power inverter and the communication device with IoT and wireless communication function; and an energy management controller connected to the power input, the digital meter, the energy storage battery pack, the power inverter, the automatic transfer switch system and the communication device with IoT and wireless communication function, and used to control the energy storage battery pack into a charge/discharge mode or into a protection mode according to a charge/discharge algorithm for the energy storage battery pack and to receive at least frequency conversion, voice or text messages from the communication device with IoT and wireless communication function, and the energy management controller controlling the automatic transfer switch system to enable an emergency power supply control procedure when a utility power grid tripping occurs in any emergency condition. The communication device with IoT and wireless communication function is used to transmit data to an emergency response center and to receive instructions from the emergency response center when the utility power grid tripping occurs during a typhoon, an earthquake or other emergency conditions.

In an embodiment, the emergency power supply control procedure includes the supply of system power to the communication device with IoT and wireless communication function in the first priority and the use of the communication device with IoT and wireless communication function to transmit data and receive instructions to and from an emergency response center when an emergency condition occurs.

To achieve at least the above objective, a further solution provided according to the present disclosure is a control method of a system with multiple functions of energy storage, Internet of things (IoT) and disaster communication. The control method includes the following steps: (A) an energy management controller determines whether a utility power grid is currently supplying power to the system or not, if not, goes to (B), and if yes, goes to (C); (B) the energy management controller controls an automatic transfer switch system to enable an emergency power supply control procedure and determines a state of charge (SoC) or energy storage of an energy storage battery pack, wherein the emergency power supply control procedure is performed when it is determined the energy storage of the energy storage battery pack is larger than a first SoC threshold, or the emergency power supply control procedure is performed while the energy management controller keeps determining the energy storage of the energy storage battery pack when it is determined the energy storage of the energy storage battery pack is smaller than the first SoC threshold, or the energy storage battery pack is controlled into a low voltage protection mode when it is determined the energy storage of the energy storage battery pack is smaller than or equal to a second SoC threshold; and wherein the first SoC threshold is larger than the second SoC threshold; and (C) the energy management controller determines a state of charge (SoC) or energy storage of an energy storage battery pack and calculates a required power consumption of a store that uses the system when it is determined the energy storage of the energy storage battery pack is larger than a first SoC threshold, or the energy management controller controls the energy storage battery pack into a peak load shaving mode when it is determined the energy storage of the energy storage battery pack is smaller than the first SoC threshold.

To achieve at least the above objective, a still further solution provided according to the present disclosure is a control method of a system with multiple functions of energy storage, Internet of things (IoT) and disaster communication. The control method includes the following steps: (a) provide a system with multiple functions of energy storage, IoT and disaster communication; the system includes a power input, a digital meter, an energy storage battery pack, a power inverter, an automatic transfer switch system, a human-machine interface and an energy management controller; the energy management controller is connected to the power input, the digital meter, the energy storage battery pack, the power inverter, the automatic transfer switch system and a communication device with Internet of things (IoT) and wireless communication function, and is used to control the energy storage battery pack into a charge/discharge mode or into a protection mode and to receive at least frequency conversion, voice or text messages from the communication device with IoT and wireless communication function; and the energy management controller controls the automatic transfer switch system to enable an emergency power supply control procedure when a utility power grid tripping occurs in any emergency condition; (b) the energy management controller determines whether a utility power grid is currently supplying power to the system or not; (c) if not, the energy management controller controls the automatic transfer switch system to enable the emergency power supply control procedure and determines a state of charge (SoC) or energy storage of the energy storage battery pack, wherein the emergency power supply control procedure is performed when it is determined the energy storage of the energy storage battery pack is larger than a first SoC threshold, or the emergency power supply control procedure is performed while the energy management controller keeps determining the energy storage of the energy storage battery pack when it is determined the energy storage of the energy storage battery pack is smaller than the first SoC threshold, or the energy storage battery pack is controlled into a low voltage protection mode when it is determined the energy storage of the energy storage battery pack is smaller than or equal to a second SoC threshold, and wherein the first SoC threshold is larger than the second SoC threshold; and (d) if yes, the energy management controller determines a state of charge (SoC) or energy storage of the energy storage battery pack and calculates a required power consumption of a store that uses the system when it is determined the energy storage of the energy storage battery pack is larger than a first SoC threshold, or the energy management controller controls the energy storage battery pack into a peak load shaving mode when it is determined the energy storage of the energy storage battery pack is smaller than the first SoC threshold.

Preferably, when the emergency power supply control procedure is enabled, the energy management controller controls the automatic transfer switch system to switch on the energy storage battery pack for the same to emergently supply power to the communication device with IoT and wireless communication function, so that the communication device with IoT and wireless communication function can transmit data to an emergency response center and receive instructions from the emergency response center.

Preferably, the energy storage battery pack in the low voltage protection mode stops releasing electrical energy and stops performing the emergency power supply control procedure, and the release of electrical energy of the energy storage battery pack is controlled by the human-machine interface.

Preferably, the energy management controller adjusts the operational power demand of the store when the calculation shows a required power consumption of the store is larger than a contract capacity thereof, and the energy management controller adjusts the operational power demand of the store by controlling the power inverter to adjust a ratio of power supplied by the utility power grid to power supplied by the energy storage batter pack, so that the power consumption of the store meets the contract capacity thereof.

Preferably, when the energy storage battery pack is in the peak load shaving mode, the energy management controller controls the power inverter to adjust a ratio of power supplied by the utility power grid to power supplied by the energy storage batter pack for the energy storage battery pack to release less electrical energy, and the energy management controller also detects a peak load time and an off-peak load time. The energy management controller controls the power inverter to charge the energy storage battery pack with the utility power grid when the off-peak load time is detected; and the energy storage battery pack is continuously charged until the energy storage thereof is larger than a third SoC threshold; and wherein the third SoC threshold is larger than the first SoC threshold.

To facilitate understanding of the technical means adopted to achieve the objects, characteristics and effects of this present disclosure, embodiments together with the attached drawings for the detailed description of the present disclosure are provided. Other objects and advantages of the present disclosure will also be explained in the following description and accompanying drawings.

### BRIEF DESCRIPTION OF THE DRAWINGS

FIG. 1 is a block diagram of a system with multiple functions of energy storage, Internet of things (IoT) and disaster communication according to a preferred embodiment of the present disclosure.

FIG. 2 is an embodiment of a flowchart of a control method of the system with multiple functions of energy storage, Internet of things (IoT) and disaster communication according to the present disclosure.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

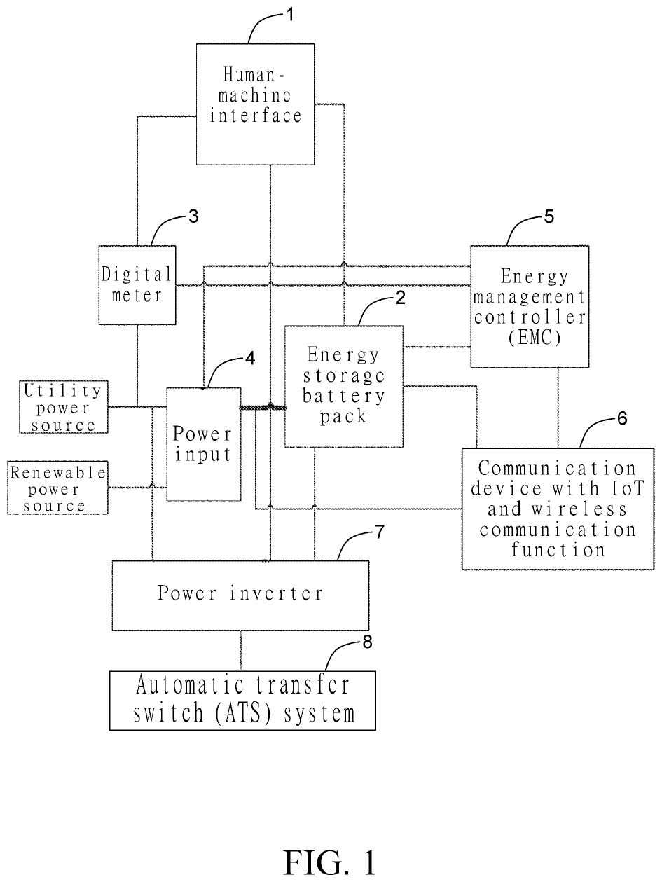

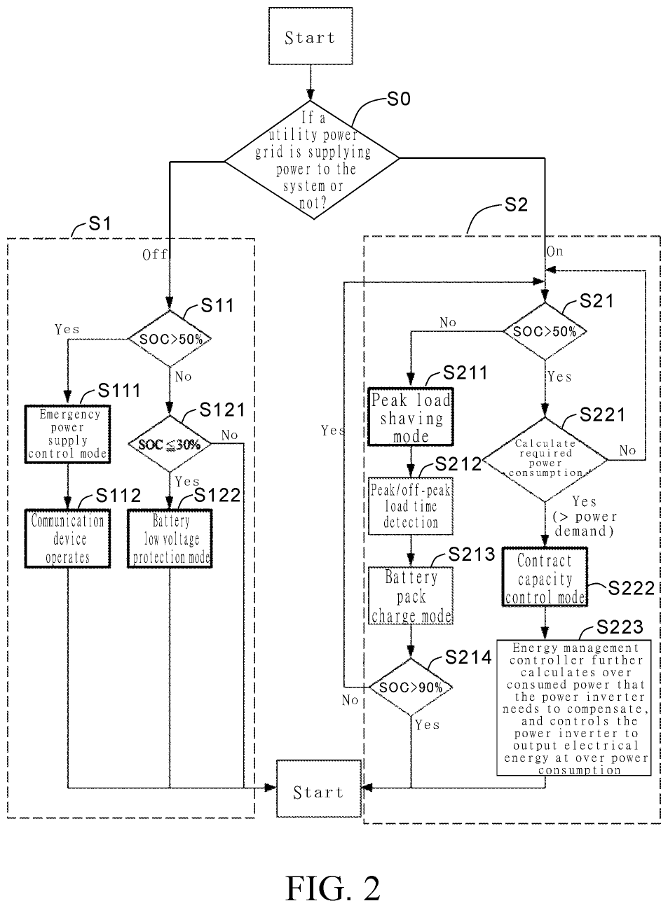

Please refer to FIG. 1, which is a block diagram of a system with multiple functions of energy storage, Internet of things (IoT) and disaster communication according to a preferred embodiment of the present disclosure; and to FIG. 2, which is an embodiment of a flowchart of a control method of the system with multiple functions of energy storage, Internet of things (IoT) and disaster communication according to the present disclosure. For the purpose of conciseness and clarity, the system with multiple functions of energy storage, Internet of things (IoT) and disaster communication according to the present disclosure is also briefly referred to as “the system” herein, and the control method thereof is also briefly referred to as “the control method” herein. As shown in FIG. 1, the system includes a human-machine interface 1, an energy storage battery pack 2, a digital meter 3, a power input 4, an energy management controller (EMC) 5, a communication device 6 with IoT and wireless communication function, a power inverter 7, and an automatic transfer switch system (ATS) 8. Further, to improve the insufficient disaster prevention and disaster communication resources in remote areas, the system and the control method thereof according to the present disclosure can be applied to stores, such as the convenience stores or other stores in the remote areas, to assist in disaster prevention and protection.

More specifically, the power input 4 is grid-connected to input endpoints of a utility power source and a renewable power source. The digital meter 3 is used to detect information about the utility power, including voltage, frequency, load current and power factor thereof. The energy storage battery pack 2 is connected to a direct current (DC) bus of the power input 4 for storing and releasing electrical energy. When a convenience store using the system of the present disclosure has power consumption exceeded its contract capacity and requires an adjustment of its operational power demand, the energy management controller 5 controls the power inverter 7 to adjust a ratio of power supplied by the utility power grid, such as the utility power source or the renewable power source, to power supplied by the energy storage battery pack 2, so that the power consumption of the store, like the convenience store, meets the contract capacity to reduce an over consumption fine. The power inverter 7 is connected to the power input 4 to be connected to the utility power grid in parallel for AC/DC power conversion. The power inverter 7 is also connected to the energy storage battery pack 2 for regulating required power consumption of the convenience store and controlling the power conversion at peak and off-peak load time. Optionally, a breaker can be used for short-circuit trip protection or leakage detection during a system short circuit. The automatic transfer switch system 8 is connected to the power inverter 7. In case of a utility power grid tripping, the automatic transfer switch system 8 switches on the energy storage battery pack 2 for the same to release and emergently supply electrical energy to the communication device 6 with IoT and wireless communication function and other food storage devices, such as refrigerators, that are used to supply and allocate food to the remote areas. The human-machine interface 1 is used to display system state information in real time and to adjust system basic parameters; wherein the system state information includes state information of the digital meter 3, the energy storage battery pack 2, power inverter 7 and the communication device 6 with IoT and wireless communication function, and controls the energy storage battery pack 2 to release electrical energy.

The energy management controller 5 is connected to the power input 4, the digital meter 3, the energy storage battery pack 2, the power inverter 7, the automatic transfer switch system 8 and the communication device 6 with IoT and wireless communication function. The energy management controller 5 is used to control the energy storage battery pack 2 into a charge/discharge mode or into a protection mode according to a charge/discharge algorithm of the energy storage battery pack 2. For example, the energy management controller 5 can determine a state of charge (SoC) or energy storage of the energy storage battery pack 2 according to step S11 or step S21 as shown in FIG. 2. When the energy storage battery pack 2 has energy storage larger than a first SoC threshold, for example, 50%, it goes to step S111 to perform an emergency power supply control procedure or goes to step S221 to calculate the required power consumption; when the SoC of the energy storage battery pack 2 is lower than or equal to a second SoC threshold, for example, 30%, it goes to step S122 to control the energy storage battery pack 2 into a low voltage protection mode or to step S211 to control the energy storage battery pack 2 into a peak load shaving mode. Wherein, the first SoC threshold is larger than the second SoC threshold.

Further, the energy management controller 5 can receive frequency conversion, voice or text messages from the communication device 6 with IoT and wireless communication function. In the case the received messages indicate an earthquake, a typhoon or any other event that could lead to interruption of utility power, the energy management controller 5 enables the emergency power supply control procedure, which includes the supply of system power to the communication device 6 with IoT and wireless communication function in the first priority, and the communication device 6 with IoT and wireless communication function receives instructions from an emergency response center, such as the reception of analog to digital messages, message format conversion, transfer of information to the cloud, etc. For instance, when a utility power grid tripping occurs in an emergency condition, such as a typhoon, an earthquake or any other condition, the energy management controller 5 controls the automatic transfer switch system 8 to enable the emergency power supply control procedure. In some examples, the emergency power supply control procedure may further include the distribution of system power to other needed devices or appliances, or to cooperate with other additional functions. Further, in the case there is power supply to the communication device 6 with IoT and wireless communication function prior to the emergency power supply control procedure, then the power is supplied to the communication device 6 with IoT and wireless communication function in the first priority when the emergency power supply control procedure is enabled, so as to ensure good communication between the communication device 6 with IoT and wireless communication function and the emergency response center.

The communication device 6 with IoT and wireless communication function is used to transmit data to the emergency response center and receive instructions from the emergency response center when the utility power grid trips in a typhoon, an earthquake or any other emergency condition.

FIG. 2 is an embodiment of a flowchart of a control method of the system with multiple functions of energy storage, Internet of things (IoT) and disaster communication according to the present disclosure. In step S0, the energy management controller 5 determines whether a utility power grid, such as a utility power source or a renewable power source, is supplying power to the system or not. If not, step S1 is performed; or if yes, step S2 is performed.

In the step S1, the energy management controller 5 controls the automatic transfer switch system 8 to enable an emergency power supply control procedure for the energy storage battery pack 2 to supply power emergently. The energy management controller 5 also determines a state of charge (SoC) or energy storage of the energy storage battery pack 2, as shown in step S11. When it is determined the energy storage battery pack 2 has energy storage larger than a first SoC threshold, for example, 50%, the step S111 is performed to start the emergency power supply control procedure. On the other hand, when it is determined the energy storage battery pack 2 has energy storage smaller than or equal to the first SoC threshold, the emergency power supply control procedure is performed while the energy management controller 5 keeps determining the energy storage of the energy storage battery pack 2. When the energy storage of the energy storage battery pack 2 is smaller than or equal to a second SoC threshold, such as 30%, as shown in step S121, goes to step S122 to control the energy storage battery pack 2 into a low-voltage protection mode. Wherein, the first SoC threshold is larger than the second SoC threshold.

In the step S2, the energy management controller 5 determines the energy storage (i.e. the state of charge, SoC) of the energy storage battery pack 2 (see step S21). When it is determined the energy storage battery pack 2 has energy storage larger than the first SoC threshold, such as 50%, the step S221 is performed to calculate a required power consumption of the convenience store using the system, such as a moving average of the required power consumption in a preset cycle time. The preset cycle time is a calculation interval used by a power company, who supplies power to the convenience store, in a contract capacity signed between the power company and the convenience store. For instance, a power consumption calculation interval for a convenience store may be set to be 15 minutes. Further, when the energy storage of the energy storage battery pack 2 is smaller than the first SoC threshold (e.g. 50%), goes to step S211 to control the energy storage battery pack 2 into the peak load shaving mode.

In the illustrated embodiment, when the emergency power supply control procedure is enabled, the energy management controller 5 controls the automatic transfer switch system 8 to switch on the energy storage battery pack 2 for the same to emergently supply power to the communication device 6 with IoT and wireless communication function, enabling the latter to transmit data to the emergency response center and to receive instructions from the emergency response center, such as reception of analog/digital messages, message format conversion and transfer of data to the cloud.

In the illustrated embodiment, the energy storage battery pack 2 in the low voltage protection mode stops releasing electrical energy and stops performing the emergency power supply control procedure. I, the release of electrical energy of the energy storage battery pack 2 is controlled by the human-machine interface 1, so that power is supplied under manual control to the communication device 6 with IoT and wireless communication function and other food storage devices, such as refrigerators, that are used to supply and allocate food to the remote areas.

In the illustrated embodiment, when the calculation shows the required power consumption of the convenience store is larger than the contract capacity, an operational power demand of the convenience store is adjusted via the energy management controller 5, which performs for example step S222 and step S223 to control the power inverter 7 to adjust a ratio of power supplied by the utility power grid to power supplied by the energy storage battery pack 2, so that the power consumed by the convenience store meets the contract capacity to reduce the over consumption fine. In the step S222, a contract capacity control mode is enabled. In the step S223, the energy management controller 5 records the store's required power consumption according to the digital meter 3 and calculates based on the calculation interval preset for the required power consumption, such as 15 minutes, to see whether the moving average of the required power consumption in the preset cycle time exceeds the contract capacity. If the contract capacity is exceeded, the energy management controller 5 further calculates the over consumed power that the power inverter 7 needs to compensate, and controls the power inverter 7 to output electrical energy.

In the illustrated embodiment, when the peak load shaving mode is enabled, the energy management controller 5 controls the power inverter 7 to adjust the ratio of power supplied by the utility power grid to power supplied by the energy storage battery pack 2 for the latter to release less electrical energy, and the energy management controller 5 also performs step S212 to detect a peak and an off-peak load time. When the energy management controller 5 detects the present is the off-peak load time, it performs step S213 to control the power inverter 7 to charge the energy storage battery pack 2 with the utility power grid until the energy storage battery pack 2 has energy storage larger than a third SoC threshold, such as 90%. Wherein, the third SoC threshold is larger than the first SoC threshold. In step S214, the energy management controller 5 determines whether the energy storage battery pack 2 has energy storage larger than the third SoC threshold, such as 90%. If yes, a new cycle of the control method starts to perform step S0 to determine whether the utility power grid, such as a utility power source or a renewable power source, is supplying power to the system; or if no, goes to the step S21.

In summary, the emergency power supply control procedure according to the preferred embodiment of the present disclosure provides the functions of assisting in disaster prevention and disaster protection by supplying power to the convenience stores located in remote areas and encountering with a power failure due to any natural disaster, so that the convenience stores can maintain emergency communication and other food storage devices, such as refrigerators, can be powered to supply and allocate food to the remote areas. The calculation of required power consumption according to the preferred embodiment of the present disclosure also enables the convenience stores in the remote areas to use the power partially supplied by the energy storage battery pack 2 in case of over power consumption, so as to meet the contract capacity and avoid possible over consumption fine. In the event the energy storage battery pack 2 of the system for the convenience stores in the remote disaster areas is about to be empty, the low voltage protection mode according to the preferred embodiment of the present disclosure enables the energy storage battery pack 2 to release electrical energy under the control of the human-machine interface 1, so that power can be supplied under manual control to the communication device 6 with IoT and wireless communication function and the food storage devices, such as refrigerators, for supplying and allocating food to the remote areas to ensure the safety of life therein. And, the peak load shaving mode according to the preferred embodiment of the present disclosure enables the utility power grid and the energy storage battery pack 2 to maintain their respective optimal state of use and takes advantage of the electrical energy from the utility power grid during the off-peak load time.

Although the system and the control method thereof according to the present disclosure in the above explanation are applied to convenience stores, it is understood the implementation of the present disclosure is not restricted thereto. In other operable embodiments, the system and the control method thereof can be applied to various kinds of stores, such as supermarkets, chain stores, and drugstores. That is, in the broad sense, the convenience store can be any store in a remote area, including but not limited to a supermarket, a chain store, a coffee shop, a restaurant or a drugstore, so as to thoroughly assist in the disaster prevention and protection.

While the present disclosure has been described by means of specific embodiments, numerous modifications and variations could be made thereto by those skilled in the art without departing from the scope and spirit of the present disclosure set forth in the claims.

What is claimed is:

1. A system with multiple functions of energy storage, Internet of things (IoT) and disaster communication, comprising:
a power input for being grid-connected to input endpoints of a utility power source and a renewable power source;
a digital meter for being used to detect information about utility power, including voltage, frequency, load current and power factor thereof;
an energy storage battery pack being connected to a direct current (DC) bus of the power input for storing and releasing electrical energy;
a power inverter for being connected to the power input and connected to a utility power grid in parallel for AC/DC power conversion; and the power inverter also being connected to the energy storage battery pack;
an automatic transfer switch (ATS) system being connected to the power inverter, for switching, in case of the utility power grid tripping, to enable the energy storage battery pack for emergency power supply, and to supply power to a communication device with Internet of things (IoT) and wireless communication function;
a human-machine interface for displaying system state information in real time and adjusting system basic parameters, wherein the system state information includes state information of the digital meter, the energy storage battery pack, the power inverter and the communication device with IoT and wireless communication function; and
an energy management controller being connected to the power input, the digital meter, the energy storage battery pack, the power inverter, the automatic transfer switch system, and the communication device with IoT and wireless communication function; the energy management controller for being used to control the energy storage battery pack into a charge/discharge mode or into a protection mode according to a charge/discharge algorithm for the energy storage battery pack, and to receive at least frequency conversion, voice or text messages from the communication device with IoT and wireless communication function; and the energy management controller controlling the automatic transfer switch system to enable an emergency power supply control procedure when a utility power grid tripping occurs in any emergency condition.

2. The system according to claim 1, wherein the communication device with IoT and wireless communication function is used to transmit data to an emergency response center and to receive instructions from the emergency response center when the utility power grid tripping occurs in an emergency condition.

3. The system according to claim 1, wherein the system is applied to a store, and the energy management controller is for being used to adjust an operational power demand of the store when a calculation shows a required power consumption of the store is larger than a contract capacity thereof, so that the power consumption of the store meets the contract capacity.

4. The system according to claim 1, wherein the system is applied to a store, and the energy management controller being used to control the power inverter to adjust a ratio of power supplied by the utility power grid to power supplied by the energy storage battery pack, so as to regulate a required power consumption of the store and to control a power conversion at peak and off-peak load time.

5. The system according to claim 1, wherein the system is applied to a store, and the store being selected from the group consisting of a supermarket, a chain store, a drugstore, and a convenience store.

6. A control method of a system with multiple functions of energy storage, IoT and disaster communication, comprising the following steps:
(a) providing a system with multiple functions of energy storage, IoT and disaster communication; the system including a power input, a digital meter, an energy storage battery pack, a power inverter, an automatic transfer switch system, a human-machine interface and an energy management controller; the energy management controller being connected to the power input, the digital meter, the energy storage battery pack, the power inverter, the automatic transfer switch system and a communication device with Internet of things (IoT) and wireless communication function, and being used to control the energy storage battery pack into a charge/discharge mode or into a protection mode and to receive at least frequency conversion, voice or text messages from the communication device with IoT and wireless communication function; and the energy management controller controlling the automatic transfer switch system to enable an emergency power supply control procedure when a utility power grid tripping occurs in any emergency condition;
(b) the energy management controller determining whether the utility power grid is currently supplying power to the system or not;
(c) if not, the energy management controller controlling the automatic transfer switch system to enable the emergency power supply control procedure and further determining a state of charge (SoC) or energy storage of the energy storage battery pack; wherein the emergency power supply control procedure is performed when it is determined the energy storage of the energy storage battery pack is larger than a first SoC threshold, or the emergency power supply control procedure is performed while the energy management controller keeps determining the energy storage of the energy storage battery pack when it is determined the energy storage of the energy storage battery pack is smaller than the first SoC threshold, or the energy storage battery pack is controlled into a low voltage protection mode when it is determined the energy storage of the energy storage battery pack is smaller than or equal to a second SoC threshold; and wherein the first SoC threshold is larger than the second SoC threshold; and
(d) if yes, the energy management controller determining a state of charge (SoC) or energy storage of the energy storage battery pack; wherein the energy management controller calculates a required power consumption of a store that uses the system when it is determined the energy storage of the energy storage battery pack is larger than a first SoC threshold, or the energy management controller controls the energy storage battery pack into a peak load shaving mode when it is determined the energy storage of the energy storage battery pack is smaller than the first SoC threshold.

7. The control method according to claim 6, wherein, when the emergency power supply control procedure is enabled, the energy management controller controls the automatic transfer switch system to switch on the energy storage battery pack for the same to emergently supply power to the communication device with IoT and wireless communication function, so that the communication device with IoT and wireless communication function can transmit data to an emergency response center and receive instructions from the emergency response center.

8. The control method according to claim 6, wherein the energy storage battery pack in the low voltage protection mode stops releasing electrical energy and stops performing the emergency power supply control procedure and the release of electrical energy of the energy storage battery pack is controlled by the human-machine interface.

9. The control method according to claim 6, wherein the energy management controller adjusts the operational power demand of the store when the calculation shows a required power consumption of the store is larger than a contract capacity thereof, and the energy management controller adjusting the operational power demand of the store by controlling the power inverter to adjust a ratio of power supplied by the utility power grid to power supplied by the energy storage batter pack, so that the power consumption of the store meets the contract capacity thereof.

10. The control method according to claim 6, wherein, when the energy storage battery pack is in the peak load shaving mode, the energy management controller controls the power inverter to adjust a ratio of an amount of power to be supplied by the utility power grid to an amount of power to be supplied by the energy storage batter pack for the energy storage battery pack to release less electrical energy, and the energy management controller also detects a peak load time and an off-peak load time; the energy management controller controlling the power inverter to charge the energy storage battery pack with the utility power grid when the off-peak load time is detected; and the energy storage battery pack being continuously charged until the energy storage thereof is larger than a third SoC threshold; and wherein the third SoC threshold is larger than the first SoC threshold.
